(19) United States
(12) Patent Application Publication
(10) Pub. No.: US 2021/0037381 A1
(43) Pub. Date: Feb. 4, 2021

(54) Method and System for Authorizing the Communication of a Network Node

(71) Applicant: Siemens Schweiz AG, Zürich (CH)

(72) Inventors: Christian Frey, Unterägeri (CH); Hilmar Konrad, Baar (CH)

(73) Assignee: Siemens Schweiz AG, Zürich (CH)

(21) Appl. No.: 16/982,660

(22) PCT Filed: Feb. 27, 2019
(86) PCT No.: PCT/EP2019/054844

§ 371 Date: Sep. 21, 2020

(30) Foreign Application Priority Data
Mar. 22, 2018 (DE) 10 2018 204 370.1

(51) Int. Cl. H04W 12/00; H04W 12/06; H04W 4/70; H04W 4/80

(52) U.S. Cl. CPC H04W 12/00503; H04W 4/80; H04W 4/70; H04W 12/06

(57) ABSTRACT

Various embodiments include a method for authorizing the communication of a network node of a communication network comprising: comparing a geographic position of the network node to a geographic position of a defined mobile communication terminal; and authorizing the network node for communication only if the geographic position of the network node and the position of a defined mobile communication terminal essentially match.

### CROSS-REFERENCE TO RELATED APPLICATIONS

This application is a U.S. National Stage Application of International Application No. PCT/EP2019/054844 filed Feb. 27, 2019, which designates the United States of America, and claims priority to DE Application No. 10 2018 204 370.1 filed Mar. 22, 2018, the contents of which are hereby incorporated by reference in their entirety.

### TECHNICAL FIELD

The present disclosure relates to communication networks. Various embodiments of the teachings herein may include methods and/or systems for authorizing the communication of a network node of a communication network and network nodes of a communication network.

### BACKGROUND

The networking of objects and devices with each other and with the Internet is increasingly penetrating everyday life, both in the private and also in the industrial environment. In the case of the so-called Internet of Things, IoT devices create a network in which they communicate with each other or with the Internet by way of suitable communication connections (e.g. WLAN). Many of the IoT devices available on the market have few or no security mechanisms at all and include to some extent various vulnerabilities and therefore represent a potential danger for their users and third parties. The number of malicious attacks on Internet-based systems, devices and applications is currently increasing dramatically.

The use of proprietary interfaces to the built-in devices by utilizing manufacturer tools such as, for example, by way of a service interface is known. Furthermore, the use of certificates to ensure a secure data transfer between the IoT devices and/or a control unit or service unit is known. Proprietary interfaces are inflexible and require additional tools on the part of a user.

Certificates can be stolen from a certification server and misused by means of hacker attacks. This is often without the knowledge of the operator of the IoT infrastructure or of a user.

### SUMMARY

The teachings of the present disclosure include methods and systems for a user-friendly and secure access to IoT devices. For example, some embodiments include a method for authorizing the communication of a network node (IoT1-IoT4, PANEL) of a communication network (IP2), wherein the authorization for communication of the network node (IoT1-IoT4, PANEL) only then takes place if the geographic position (POS_{BIM}) of the network node (IoT1-IoT4, PANEL) and the position (POS, POS_{IPS}) of a defined mobile communication terminal (SMART) essentially match.

In some embodiments, the position (POS_{BIM}) of the network node (IoT1-IoT4, PANEL) in a building model (BIM) is stored on a server (BIM server) and wherein the position (POS, POS_{IPS}) of the mobile communication terminal (SMART) is determined by way of a position determination system (IPS).

In some embodiments, the server (BIM server, CSA) is configured so that verification of the position takes place on the server (BIM server, CSA).

In some embodiments, the network node (IoT1-IoT4, PANEL) is configured so that verification of the position (POS, POS_{BIM}, POS_{IPS}) takes place in or by means of the network node (IoT1-IoT4, PANEL).

In some embodiments, the mobile communication terminal (SMART) is configured so that verification of the position (POS, POS_{BIM}, POS_{IPS}) takes place in the mobile communication terminal (SMART).

In some embodiments, the mobile communication terminal (SMART) is configured to verify the position (POS, POS_{BIM}, POS_{IPS}) so that verification of the position (POS, POS_{BIM}, POS_{IPS}) of network nodes (IoT1-IoT4, PANEL) and mobile communication device (SMART) takes place by way of an NFC connection between the network node (IoT1-IoT4, PANEL) and the mobile communication terminal (SMART).

In some embodiments, during the duration of a communication the position of the network node (IoT1-IoT4, PANEL) and the position (POS, POS_{IPS}) of the mobile communication terminal (SMART) essentially match.

In some embodiments, the mobile communication terminal (SMART) receives a certification by way of a certification server.

In some embodiments, a write access to a memory (M) of the authorized network node (IoT1-IoT4, PANEL) is only permitted following a completed authorization.

As another example, some embodiments include a system for authorizing the communication of a network node (IoT1-IoT4, PANEL) of a communication network (IP2), wherein the network node (IoT1-IoT4, PANEL) is configured so that authorization for communication of the network node (IoT1-IoT4, PANEL) only then takes place if the geographic position (POS_{BIM}) of the network node (IoT1-IoT4, PANEL) and the position (POS, POS_{IPS}) of a defined mobile communication terminal (SMART) essentially match.

In some embodiments, there is a server (BIM server), on which a building model (BIM) is stored with the position (POS_{BIM}) of the network node (IoT1-IoT4, PANEL); and a position determination system (IPS) for determining the position (POS, POS_{IPS}) of the mobile communication terminal (SMART).

In some embodiments, the network node (IoT1-IoT4, PANEL) and/or the server (BIM server, CSA) and/or the mobile communication terminal (SMART) are configured for checking the positions (POS, POS_{BIM}, POS_{IPS})

In some embodiments, following completed authorization the network node (IoT1-IoT4, PANEL) is configured to allow a write access to a memory (M) of this authorized network node (IoT1-IoT4, PANEL).

As another example, some embodiments include a network node (IoT1-IoT4, PANEL) of a communication network (IP2), wherein the network node (IoT1-IoT4, PANEL) is configured so that it can only carry out a communication if the position (POS_{BIM}) of the network node (IoT1-IoT4, PANEL) and the position (POS, POS_{IPS}) of a defined mobile communication terminal (SMART) essentially match.

In some embodiments, the network node (IoT1-IoT4, PANEL) is an IoT device.

In some embodiments, following completed authorization the network node (IoT1-IoT4, PANEL) is configured to allow a write access to a memory (M) of this authorized network node (IoT1-IoT4, PANEL).

### BRIEF DESCRIPTION OF THE DRAWINGS

The teachings herein as well as example embodiments of the present teachings are explained using the example of the following figures.

In the drawings:

FIG. 1 shows a first exemplary system incorporating teachings of the present disclosure for authorizing the communication of a network node of a communication network,

FIG. 2 shows a second exemplary system incorporating teachings of the present disclosure for authorizing the communication of a network node of a communication network, and

FIG. 3 shows a flow diagram for an example method incorporating teachings of the present disclosure for authorizing the communication of a network node of a communication network.

### DETAILED DESCRIPTION

Some embodiments of the teachings herein include a method for authorizing the communication (e.g. data connection e.g. for carrying out a download or an upload of data) of a network node (e.g. IoT device) of a communication network (e.g. IP network), wherein the authorization for communication of the network node only then takes place if the geographic position of the network node and the position of a defined certified mobile communication terminal (e.g. smartphone) essentially match. A communication comprises, for example, receiving or sending data, files, signals, commands, parameters to other network nodes, to a panel, to a cloud or to the mobile communication terminal. A network node (e.g. IoT device) is then only authorized to carry out a communication (e.g. a firmware update or an update of operating parameters of the IoT device) if a defined mobile communication terminal (e.g. a mobile communication terminal comprising a quantity of certified mobile communication terminals) is located geographically at a defined maximum distance from the corresponding network node. The defined maximum distance may be 5 m, in particular 3 m, for instance.

In some embodiments, authorization of the network node for a communication takes place only after the user of the certified mobile communication terminal is identified. The user may be identified at a defined maximum distance from the network node. The user can be identified biometrically (e.g. finger print), by way of PIN input or PKI (Public Key Infrastructure). The geographic position of the network node can for example be stored in the network node, e.g. in a storage area of the network node.

In some embodiments, an authorization of the network node takes place for a communication in addition to verifying the match between the geographic position of network nodes and mobile communication terminal also in addition by means of a further authorization of the network node (e.g. by means of a release by a control center, an additional node in the network or by registration of the device in the IP network itself (by means of corresponding access authorization)). This two-factor verification or two-factor authorization provides a high degree of security for the access to the network node. In some embodiments, in the case of two-factor verification or two-factor authorization an initial verification or authorization takes place by means of the IP access itself (virtual component). A second verification or authorization takes place by way of a physical component (verifying the match between the geographic position/location of the devices). Only when the first and second verification or authorization have taken place can the data transfer be activated for the network node. In some embodiments, the physical access to the network node (e.g. IoT device in a building) is ensured by means of an access control system. This would imply a three-factor verification or three-factor authorization.

The methods incorporating teachings of the present disclosure may be used for the installation and/or maintenance of network nodes in a building or within a building automation. Network nodes can be, for example, IoT devices, or hazard detectors and/or fire detectors, controllers for sensors and/or actuators, actuating drives or bus subscribers of an installation bus (e.g. KNX bus). For example, in some embodiments, the position of the network node in a building model is stored on a server and in the position of the mobile communication terminal being determined by way of a position determination system. The position determination system is advantageously an indoor position determination system. The indoor position determination system can be based e.g. on WLAN technology (using Wi-Fi access points) or on Bluetooth technology (e.g. BLE). A satellite-assisted position determination system (e.g. GPS) can, in principle, also be used.

In some embodiments, the network node and the server are located in the same network (e.g. an IP network, based on IPv4 or IPv6). The building model may be a building information model (BIM). All relevant data for a building and for the built-in infrastructure (heating, ventilation, air-conditioning, security, fire protection, etc.) of the building may be stored in the building information model (BIM). For instance, information relating to the fire detector installed in the building (type, manufacturer, year of manufacture, position, etc.) is therefore stored in the building information model (BIM). The building information model (BIM) can be based e.g. on IFC (Industry Foundation Classes).

In some embodiments, the position is verified on the server. The server can learn the position of the network node from the building information model (BIM). The building information model (BIM) can be stored here in a database, to which the server has access. The building information model (BIM) may be located in an in-memory database (e.g. Hana). If the geographic position of the network node is stored in a storage area (e.g. flash memory) of the network node, the server can however also query the geographic position of the network node from the network node itself. The server and the network node may be located in the same network. The server can however also be located in a cloud infrastructure and communicate with the network node and with the mobile communication device (e.g. smartphone) by way of suitable communication mechanisms (e.g. radio). The server and the mobile communication device may be trusted devices.

In some embodiments, the network node is configured so that the position is verified in or by means of the network node. The geographic position of the network node is stored in a storage area (e.g. flash memory) of the network node. If the network node comprises suitable and adequate processing logic (or comprises computing power) and suitable communication mechanisms (e.g. radio), the comparison of the position of the network node with the position of the mobile communication terminal can take place in or by means of the network node. The network node and the mobile communication device are advantageously trusted devices.

In some embodiments, the mobile communication terminal is configured so that the position is verified in the mobile communication terminal. The geographic position of the network node can be stored in the network node (e.g. in a corresponding memory of the network node) and/or in the building information model (BIM), to which the server has access. The mobile communication terminal obtains the geographic position of the network node by way of suitable communication mechanisms (e.g. radio) and compares the same with its own geographic position. Present-day mobile communication terminals (e.g. smartphones) are configured to be able to determine their respective geographic position. This can take place e.g. by way of a satellite-assisted position determination system (e.g. GPS) and/or an indoor position determination system (e.g. WLAN, Bluetooth (in particular Bluetooth Low Energy (BLE), iBeacons) installed in a building. If the position of the mobile communication terminal matches the position of the network node, the mobile communication terminal can transfer an authorization (e.g. activation signal, approval message) for communication (e.g. firmware upload) to the network node. The network node, the mobile communication device and the server are advantageously trusted devices.

In some embodiments, the mobile communication terminal is configured to verify the position so that the position of network nodes and mobile communication terminal is verified by way of an NFC connection between the network node and the mobile communication terminal. A near-field communication (NFC) between the mobile communication terminal and the network node can be established for example by way of RFID (radio frequency identification) or by means of Bluetooth. A near-field communication requires both of the devices which are to be connected to be spatially close to one another (e.g. 2-3 m). If the mobile communication terminal and the network node have an NFC connection installed between them, this can be seen as evidence that their respective geographic position essentially corresponds (e.g. at a distance of 2-3 m).

In some embodiments, the position of the network node and the position of the mobile communication terminal essentially match during the duration of a communication. This increases further the security of the access to the network node and the security of the communication with the network node. The mobile communication terminal must for example be located in the vicinity of the network node for the entire duration of a firmware update (e.g. at a distance of 2-3 m).

In some embodiments, the mobile communication terminal receiving a certification, i.e. a certification for authorization from a certification server (e.g. trusted server). For example a certification server can generate digital certificates by means of a suitable asymmetric encryption method and transfer said certificates to mobile communication terminals. A digital certificate may be valid only for a specific time period and/or for a defined number of authorizations and/or for defined network nodes (e.g. network nodes in a particular area of the building (e.g. a particular room). This increases further the security of the access to the network node and the security of the communication with the network node.

In some embodiments, a write access to a memory of the authorized network node is only permitted following a completed authorization. The write access can take place for example by way of further network nodes, by way of the mobile communication terminal or by way of a server. The server may be located in a cloud infrastructure and is suitably configured for a communication with the network node.

In some embodiments, there is a system for authorizing the communication (e.g. data connection) of a network node (e.g. IoT device) of a communication network (e.g. IP network), wherein the network node is configured so that authorization for communication of the network node only then occurs if the geographic position of the network node and the position of a defined (or certified) mobile communication terminal (e.g. smartphone) essentially match. A communication comprises, for example, receiving or sending data, files, signals, commands, parameters to other network nodes, to a panel, to a cloud or to the mobile communication terminal. A network node (e.g. IoT device) is then only authorized to carry out a communication (e.g. a firmware update) if a defined mobile communication terminal (e.g. a mobile communication terminal comprising a quantity of certified mobile communication terminals) is located geographically at a defined maximum distance from the corresponding network node. The defined maximum distance may be a distance of 5 m, in particular 3 m, for instance. In some embodiments, authorization of the network node for a communication takes place only after the user of the certified mobile communication terminal is identified. The user may be identified at a defined maximum distance from the network node. The user can be identified biometrically (e.g. finger print), byway of a PIN entry or PKI (Public Key Infrastructure). The geographic position of the network node can be stored in the network node, e.g. in a storage area of the network node.

In some embodiments, an authorization of the network node takes place for a communication in addition to verifying the match between the geographic position of network nodes and mobile communication terminal also by means of a further authorization of the network node (e.g. by means of approval by a control center, or a further node in the network). This two-factor verification or two-factor authorization provides a high degree of security for the access to the network node. In the case of two-factor verification or two-factor authorization an initial verification or authorization may take place by means of the IP access itself (virtual component).

In some embodiments, a second verification or authorization takes place by way of a physical component (verifying the match between the geographic position/location of the devices). Only when the first and second verification or authorization have taken place can the data transfer be activated for the network node. The physical access to the network node (e.g. IoT device in a building) may be ensured by means of an access control system. This would imply a three-factor verification or three-factor authorization and increase security. The system can be realized with an infrastructure which already exists anyway in a building. Network nodes can be, for example, IoT devices, or hazard detectors and/or fire detectors, controllers for sensors and/or actuators, or bus subscribers of an installation bus (e.g. KNX bus).

In some embodiments, there is a server on which a building model (BIM) with the position of the network node is stored; and a position determination system for determining the position of the mobile communication terminal. The server may be a network-compatible (e.g. IP network, Internet) database server which can be accessed by clients. The building model (BIM, Building Information Model) may be located e.g. in an in-memory database (e.g. Hana) of the server. The position determination system can be e.g. a satellite-assisted position determination system and/or an indoor position determination system (e.g. iBeacons). Mobile communication terminals (e.g. smartphones) are nowadays configured to determine their geographic position in cooperation with position determination systems.

In some embodiments, the network node and/or the server and/or the mobile communication terminal may be configured to verify the positions. Depending on the application or available infrastructure, a corresponding system can thus be realized flexibly.

In some embodiments, following the completed authorization, the network node is configured to allow a write access to a memory of this authorized network node (e.g. by way of further network nodes, the server or by way of the mobile communication terminal). The server is advantageously located in a cloud infrastructure and is suitably configured for a communication with the network node.

In some embodiments, there is a network node of a communication network (e.g. IP network), wherein the network node is configured in such a way that it can only carry out a communication if the position of the network node and the position of a defined (certified) mobile communication terminal (e.g. smartphone) essentially match (e.g. at a distance of 3-5 m). Network nodes configured in this way have a high protection against unauthorized access. Network nodes can be, for example, IoT devices, or hazard detectors and/or fire detectors, controllers for sensors and/or actuators, or bus subscribers of an installation bus (e.g. KNX bus).

In some embodiments, the network node comprises an IoT device. An IoT device (IoT stands for Internet of Things) is physical and/or virtual objects which are connected to one another and/or to the Internet. IoT devices can have different performance capabilities depending on the specification (hardware, software, processor, memory).

In some embodiments, following the completed authorization, the network node is configured to allow a write access to a memory of this authorized network node (e.g. by way of further network nodes, by way of the server or by way of the mobile communication terminal). This ensures, among other things, an increased protection against hacker attacks or man-in-the-middle attacks (MITM attack) on the network node.

IoT devices (e.g. Internet-ready devices) must meet a minimum level of security criteria in order to be implemented in institutions. The devices must have update functions and the manufacturer must offer an update process. If IoT solutions (solutions relating to the Internet of Things) have insufficient or no patch management (elimination of errors), it is not possible to eliminate any vulnerabilities. As an alternative the security vulnerabilities would have to be shielded by another means. This can become very costly and can also lead the entire usage concept of an IoT device to the point of absurdity. The teachings of the present disclosure apply to the secured/authorized access to safety-related devices installed in the building such as, for example, smoke detectors, alarming devices, actuating drives for smoke flaps, extinguishing valves etc. as if data security is jeopardized technical progress is hindered.

The dissemination and introduction of IoT technology also in the building sector results in an increased security risk as regards the manipulation of installed safety-related infrastructure. The deliberate triggering of a false alarm can therefore lead to an evacuation of a hotel, which has negative consequences for the hotel and for the hotel guests, such as for example accidents during the panic. This can lead, inter alia, to ransom demands. The intended purpose can also be compromised by changes to the devices which cannot be verified (suppressing the alarm triggering of a smoke detector).

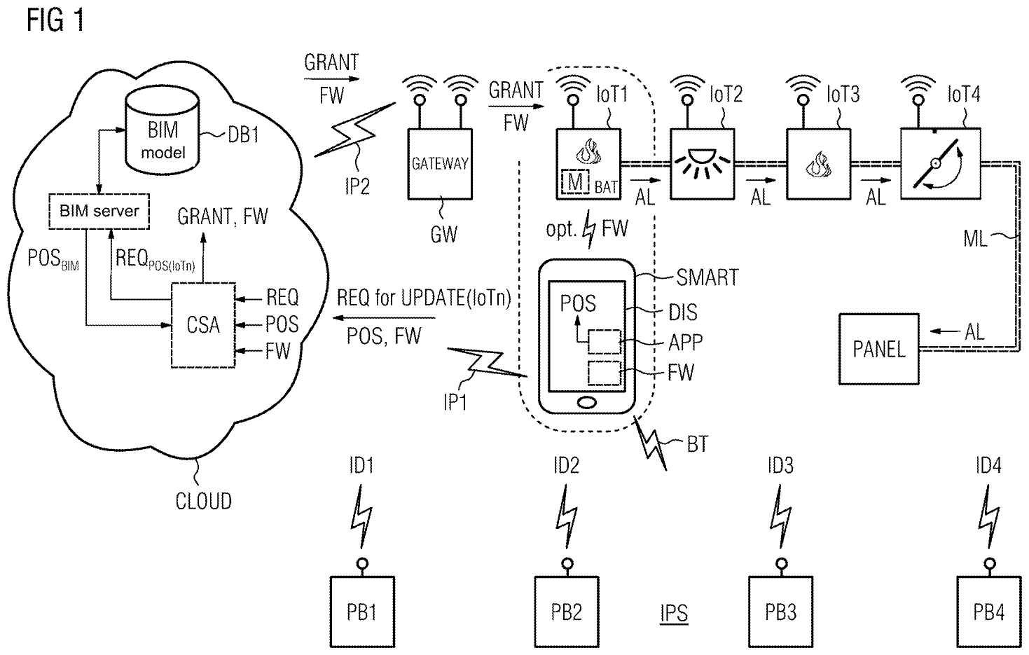

FIG. 1 shows a first exemplary system for authorizing the communication (e.g. data connection, data exchange, download or upload of data or parameters) of a network node IoT1-IoT4 (e.g. IoT device) of a communication network IP2 (e.g. IP network), wherein the network node IoT1-IoT4 is configured so that authorization for communication of the network node IoT1-IoT4 only then takes place if the geographic position POS_{BIM} of the network node IoT1-IoT4 and the position POS of a defined (certified) mobile communication terminal SMART (e.g. smartphone) essentially match. A network node IoT1-IoT4 can only then communicate with other network nodes IoT1-IoT4 or devices (e.g. mobile communication terminals) if a mobile communication terminal SMART (e.g. smartphone, tablet computer, PDA (Personal Digital Assistant)) is located in the immediate vicinity (e.g. at a maximum distance of 3-5 m, in particular a maximum of 3 m).

The communication network IP2 is for example an IP network which is based on an IP protocol (Internet Protocol, e.g. IPv4 or IPv6). In some embodiments, a network node IoT1-IoT4 is an Internet-ready IoT device. In buildings it is, for example, correspondingly configured hazard detectors or fire detectors, or correspondingly configured operating and monitoring stations PANEL.

The exemplary system according to FIG. 1 comprises a server BIM server, on which a building model (BIM model) with the position POS_{BIM} of the network node is stored; and a position determination system IPS for determining the position POS of the mobile communication terminal SMART. The server (BIM server) is a correspondingly configured computer with corresponding hardware and software (processor, memory, interfaces, communication mechanisms (e.g. radio)). The building model (BIM model) is stored on a database DB1, for instance, which can be accessed by the server (BIM server).

The position determination system IPS can be a satellite-assisted position determination system (e.g. GPS) and/or an indoor position determination system, which is based on WLAN or Bluetooth BT, for instance. The comparison of the position of the network node IoT1-IoT4 and the position of the mobile communication terminal can take place by means of the network node IoT1-IoT4, by means of the server (BIM server) or by means of the mobile communication terminal SMART. To this end the network node IoT1-IoT4, the server (BIM server) and the mobile communication terminal SMART are equipped with corresponding processing logic.

In some embodiments, the network node IoT1-IoT4 is configured so that following completed authorization a write access to a memory M (e.g. flash memory) of the authorized network node is possible. The write access can take place for example by means of additional network nodes of the IP network IP2, and/or by way of the mobile communication terminal SMART, and/or by means of the server (BIM server). Write access can for example relate to a firmware update or an update of operating parameters of the IoT device.

With the exemplary system according to FIG. 1, a network node IoT1-IoT4, PANEL is configured so that it can only carry out a communication if the position POS_{BIM} of the network node IoT1-IoT4 and the position POS of a defined (advantageously certified) mobile communication terminal SMART (e.g. smartphone) essentially match, i.e. if both devices are located in the immediate vicinity (e.g. within a distance of at most 3-5 m). The network node IoT1-IoT4, PANEL is advantageously an IoT device which is connected to other devices or to the Internet by way of an IP connection IP2.

In the system according to FIG. 1 the IoT device IoT1 only receives an authorization GRANT for a communication (e.g. firmware update FW) once the mobile communication terminal SMART is located in the immediate vicinity (e.g. within a distance of 5 m, in particular 3 m) of the device IoT1. In the representation according to FIG. 1 the spatial proximity is shown by the dashed line, within which the mobile communication terminal SMART and the IoT device IoT1 are located.

In the representation according to FIG. 1, the position determination system IPS is formed by positioning beacons PB1-PB4, which each emit their respective identification ID1-ID4. The respective ID1-ID4 is detected by the mobile communication terminal SMART, e.g. by way of a Bluetooth BT connection (advantageously BLE, Bluetooth Low Energy). Based on the respective identification ID1-ID4 received from the mobile communication terminal SMART, the mobile communication terminal SMART determines its respective geographic position POS. The identification ID1-ID4 can also directly contain the geographic spatial position of the respective beacon PB1-PB4.

The mobile communication terminal SMART comprises a corresponding app APP for position determination and firmware FW, which is to be loaded onto the device IoT1 (upload). A user (e.g. a commissioning engineer or a maintenance technician) can carry out corresponding operator inputs on the display DIS of the mobile communication terminal SMART.

The mobile communication terminal SMART sends a request REQ by way of a corresponding IP connection IP1 (Internet Protocol connection) for an update for the corresponding device IoTn to a cloud service application CSA which is realized by means of a cloud infrastructure CLOUD. The cloud service application CSA receives the request REQ, the geographic spatial position POS of the mobile communication terminal SMART and the firmware FW, which is to be uploaded to the corresponding device IoTn.

The cloud service application CSA sends a request REQ_{POS(IoTn)} to the BIM server in order to obtain the position of the corresponding device IoTn, for which the firmware update is to take place. The BIM server accesses the database DB1 with the building model (BIM) and makes the position POS_{BIM} of the corresponding device IoTn available to the cloud service application CSA.

The cloud service application CSA compares the spatial position POS of the mobile communication terminal SMART with the position POS_{BIM}, supplied by the BIM server, of the corresponding device IoTn, on which the firmware update FW is to take place. If the two positions essentially correspond, the cloud service application CSA gives an approval or authorization GRANT for a communication by way of the IP connection IP2 to the corresponding device IoTn. The cloud service application CSA can access the IP network for the IP connection IP2 by way of a gateway GW or can also directly access the corresponding IoT device IoT1-IoT4.

The firmware update FW or the firmware upload can take place on the corresponding IoT device IoT1-IoT4 (in the exemplary representation according to FIG. 1 the device IoT1) by the cloud infrastructure CLOUD, by way of the IP connection IP2 or by the mobile communication terminal SMART on the IoT device IoT1, e.g. by means of a NFC connection (near field communication) between the mobile communication terminal SMART and the IoT device IoT1. An NFC connection (near field communication) between the mobile communication device SMART and the IoT device IoT1 can take place by way of Bluetooth or RFID (Radio Frequency Identification), for instance. The cloud service application CSA and the BIM server can be realized physically in a computer. The IP connections IP1, IP2 are advantageously radio-based connections (e.g. WLAN).

In the exemplary representation according to FIG. 1 the IoT device IoT1 is a fire detector which is connected to other devices IoT1-IoT4 by way of a detector line ML with a corresponding control station or fire detector control unit PANEL (e.g. FS20 control unit). An alarm message AL can thereby be forwarded by way of the detector line ML from a device IoT1-IoT4 to the control unit PANEL.

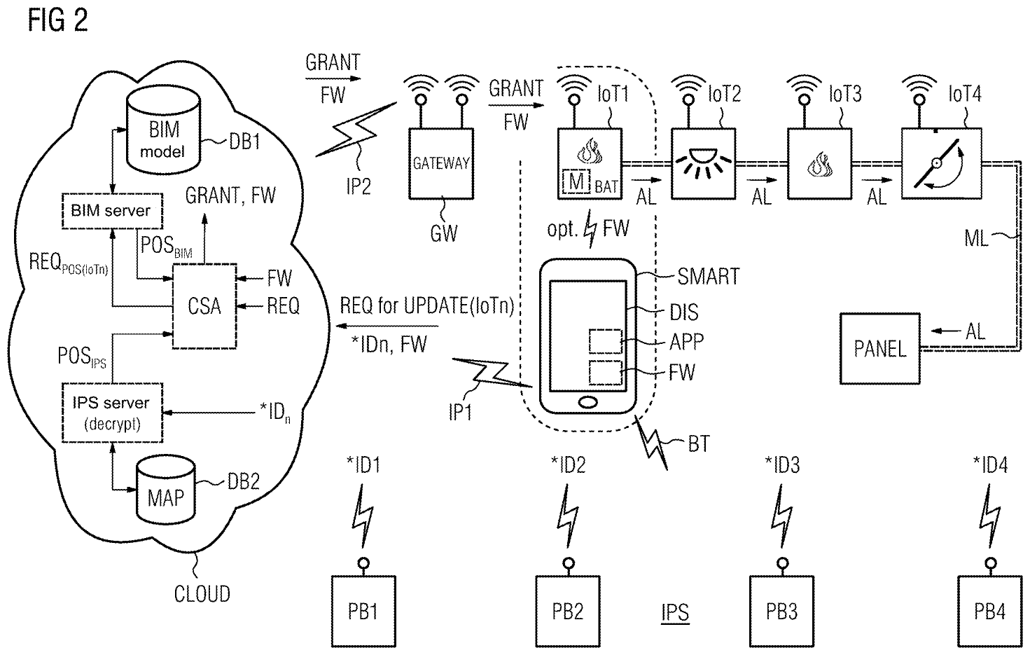

FIG. 2 shows a second exemplary system for authorizing the communication (e.g. data connection, data exchange, download or upload of data or parameters) of a network node IoT1-IoT4 (e.g. IoT device) of a communication network (e.g. IP network), wherein the network node IoT1-IoT4 is configured so that authorization for communication of the network node IoT1-IoT4 only then occurs if the geographic position POS_{BIM} of the network node IoT1-IoT4 and the position POS_{IPS} of a defined (certified) mobile communication terminal SMART (e.g. smartphone) essentially match. A network node IoT1-IoT4 can only then communicate with other network nodes IoT1-IoT4 or devices (e.g. mobile communication terminals) if a mobile communication terminal SMART (e.g. smartphone, tablet computer, PDA (Personal Digital Assistant)) is located in the immediate vicinity, (e.g. at a maximum distance of 5 m, in particular a maximum of 3 m).

The communication network IP2 is for example an IP network which is based on an IP protocol (Internet Protocol, e.g. IPv4 or IPv6).

A network node IoT1-IoT4 is advantageously an Internet-ready IoT device. In buildings it is, for example, correspondingly configured hazard detectors or fire detectors, or correspondingly configured operating and monitoring stations PANEL.

The exemplary system according to FIG. 2 comprises a server BIM server, on which a building model (BIM model) with the position POS_{BIM} of the network node is stored; and a position determination system IPS for determining the position POS_{IPS} of the mobile communication terminal SMART. The server (BIM server) is a correspondingly configured computer with corresponding hardware and software (processor, memory, interfaces, communication mechanisms (e.g. radio)). The building model (BIM model) is stored on a database DB1, for instance, which can be accessed by the server (BIM server). The building model (BIM model) is stored and memorized in a suitable notation or a suitable format, e.g. IFC (Industry Foundation Classes).

The position determination system IPS can be a satellite-assisted position determination system (e.g. GPS) and/or an indoor position determination system, which is based on WLAN or Bluetooth BT, for instance. The comparison of the position of the network node IoT1-IoT4 and the position of the mobile communication terminal can take place by means of the network node IoT1-IoT4, by means of the server (BIM server) or by means of the mobile communication terminal SMART. To this end the network node IoT1-IoT4, the server (BIM server) and the mobile communication terminal SMART are equipped with corresponding processing logic.

The network node IoT1-IoT4 may be configured so that following completed authorization a write access to a memory M of the authorized network node is possible. The write access can take place for example by means of additional network nodes of the IP network, and/or by way of the mobile communication terminal SMART, and/or by means of the server (BIM server). Write access can for example relate to a firmware update FW or an update of operating parameters of the IoT device. The memory M can be a flash memory, for instance.

With the exemplary system according to FIG. 2, a network node IoT1-IoT4, PANEL is configured so that it can only carry out a communication if the position POS_{BIM} of the network node IoT1-IoT4 and the position POS_{IPS} of a defined (advantageously certified) mobile communication terminal SMART (e.g. smartphone) essentially match, i.e. if both devices are located in the immediate vicinity (e.g. within a distance of at most 5 m, in particular at most 3 m). The network node IoT1-IoT4, PANEL may be an IoT device which is connected to other devices or to the Internet by way of an IP connection (connection based on the Internet Protocol).

In the exemplary system according to FIG. 2 the IoT device IoT1 only receives an authorization GRANT for a communication (e.g. firmware update FW) once the mobile communication terminal SMART is located in the immediate vicinity (e.g. within a distance of 5 m, in particular 3 m), of the device IoT1. In the representation according to FIG. 2 the spatial proximity is shown by the dashed line, within which the mobile communication terminal SMART and the IoT device IoT1 are located.

In the representation according to FIG. 2, the position determination system IPS is formed by positioning beacons PB1-PB4, which each emit their respective identification ID1-ID4.

The respective ID1-ID4 is detected by the mobile communication terminal SMART, e.g. by way of a Bluetooth BT connection (e.g. BLE, Bluetooth Low Energy). On the basis of the respective identification ID1-ID4 received by the mobile communication terminal SMART, the mobile communication terminal SMART determines its respective geographic position POS_{IPS}. The identification ID1-ID4 can also contain directly the geographic spatial position of the respective beacon PB1-PB4.

The mobile communication terminal SMART comprises a corresponding app APP for receiving the respective identification *ID1-*ID4 of the respective beacons PB1-PB4. The respective identifications *ID1-*ID4 may be suitably encrypted. Furthermore, the firmware FW, which is to be uploaded onto the device IoT1, is located on the mobile communication terminal SMART. A user (e.g. a commissioning engineer or a maintenance technician) can perform corresponding operator inputs on the display DIS of the mobile communication terminal SMART.

The mobile communication terminal SMART sends a request REQ by way of a corresponding IP connection IP1 (Internet Protocol connection) for an update (REQ for UPDATE (Iotn)) for the corresponding device IoTn to a cloud service application CSA which is realized by means of a cloud infrastructure CLOUD. The cloud service application CSA receives the request REQ and the firmware FW, which is to be uploaded to the corresponding device IoTn.

In the exemplary system according to FIG. 2, the mobile communication terminal SMART sends the respective identification *IDn of the corresponding beacon PB1-BP4, in the geographic vicinity of which the mobile communication terminal SMART is located, to the IPS server which is also in the cloud infrastructure CLOUD. The identification *IDn may be transferred encrypted to the IPS server, in which this is decrypted for further processing. The identification *IDn can be encrypted by means of an asymmetric cryptography, for instance.

The IPS server has access to a map MAP with the local information, i.e. the installation sites of the respective positioning beacons PB1-PB4. The IPS server can determine the spatial position of the respective beacon PB1-PB4 by way of the respective identification *IDn and provide it to the cloud service application CSA. The map MAP may be located in a suitable format in a database DB2.

The cloud service application CSA sends a request REQ_{POS(IoTn)} to the BIM server in order to obtain the position of the corresponding device IoTn, for which the firmware update is to take place. The BIM server accesses the database DB with the building model (BIM) and makes the position POS_{BIM} of the corresponding device IoTn available to the cloud service application CSA.

The cloud service application CSA compares the spatial position POS_{IPS} of the mobile communication terminal SMART with the position POS_{BIM}, supplied by the BIM server, of the corresponding device IoTn, on which the firmware update FW is to take place. If the two positions essentially correspond, the cloud service application CSA gives an approval or authorization GRANT for a communication by way of the IP connection IP2 to the corresponding device IoTn. The cloud service application CSA can access the IP network for the IP connection IP2 by way of a gateway GW or can also directly access the corresponding IoT device IoT1-IoT4.

The firmware update FW or the firmware upload can take place on the corresponding IoT device IoT1-IoT4 (in the exemplary representation according to FIG. 2 the device IoT1) by the cloud infrastructure, by way of the IP connection IP2 or by the mobile communication terminal SMART on the IoT device IoT1, e.g. by an NFC connection (near field communication) between the mobile communication terminal SMART and the IoT device IoT1. An NFC connection (near field communication) between the mobile communication terminal SMART and the IoT device IoT1 can take place by way of Bluetooth or RFID (Radio Frequency Identification), for instance. The cloud service application CSA, the BIM server and the IPS server can be realized physically in a computer. The IP connections IP1, IP2 may be radio-based connections (e.g. WLAN).

In the exemplary representation according to FIG. 2 the IoT device IoT1 is a fire detector which is connected to the other devices IoT1-IoT4 by way of a detector line ML with a corresponding control station or fire detector control unit PANEL (e.g. FS20 control unit). An alarm message AL can thereby be forwarded by way of the detector line ML from a device IoT1-IoT4 to the control unit PANEL.

It should be noted with respect to the exemplary systems according to FIG. 1 and FIG. 2 that the components of the cloud infrastructure CLOUD are virtually different components, but these can be implemented or realized in a computer (e.g. a cloud server). BIM server, CSA (cloud service application) and IPS server are virtually different components or modules. They can be implemented and realized on a (single) computer or on a computer system (which can also be distributed). The databases DB1, DB2 can be realized in each case as an in-memory database (e.g. Hana) for instance, as a result inter alia rapid access times are possible, which enables rapid authorization and therefore also e.g. a rapid firmware update.

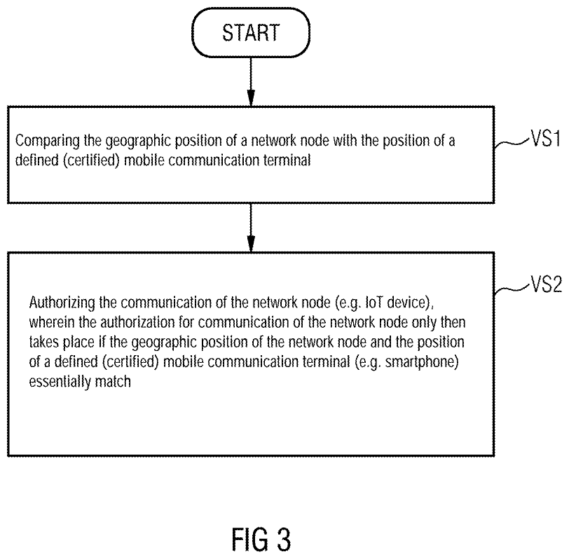

FIG. 3 shows an exemplary flow diagram for a method for authorizing the communication (e.g. data connection, sending or receiving data) of a network node (e.g. IoT device) of a communication network (e.g. IP network), wherein the authorization for communication of the network node only takes place if the geographic position of the network node and the position of a defined (certified) mobile communication terminal (e.g. smartphone) essentially match. The position of the network node may be stored in a building model on a server, and the position of the mobile communication terminal is determined by way of a position determination system (e.g. indoor position determination system).

The verification and the comparison of the positions can take place on the server. The verification and the comparison of the positions can however also take place on the network node or the mobile communication terminal (e.g. smartphone). The mobile communication terminal may be configured so that the position of the network node and the mobile communication terminal is verified by way of an NFC connection (e.g. RFID, Bluetooth) between the network node and the mobile communication terminal. The position of the network node and the position of the mobile communication terminal essentially advantageously match during the duration of a communication. The mobile communication terminal receives a certification (token, certificate; in fact certification for authorization) from a certification server (trusted server).

In some embodiments, write access to a memory (e.g. flash memory) of the authorized network node is only allowed after authorization. Write access can take place e.g. by way of further network nodes or by way of the mobile communication terminal.

In some embodiments, a method includes:

(VS1) comparing the geographic position of a network node with the position of a defined (certified) mobile communication terminal; and

(VS2) authorizing the communication of the network node (e.g. IoT device), wherein the authorization for communication of the network node only then takes place if the geographic position of the network node and the position of a defined (certified) mobile communication terminal (e.g. smartphone) essentially match.

These method steps can be realized with an infrastructure which already exists anyway in a building. It is known that a comprehensive security strategy is required to protect an IoT infrastructure (Internet of Things). This strategy must cover the following areas: securing data in the cloud, protecting the integrity of the data during transfer by way of the public Internet as well as the secure provision of devices. Each layer makes its own contribution to the security of the overall infrastructure, and the contributions build on one another and complement each other.

The most serious attacks on the IoT infrastructure itself start with a direct data-related access to the IoT devices on site in the direct environment of the respective IoT device. In some embodiments, the methods and systems prevent a direct data-related attack from the outside on the IoT devices. In some embodiments, a data-related access (directly or by way of the server or the control center) to the IoT device only then takes place if in the BIM (for Building Information Modeling) the position of the device in the building matches the position of the authorized service technician or the position of the smartphone of the service technician in the building. To this end the built-in position of the device in the BIM is compared with the position of the smartphone of the service technician, e.g. by way of the IPS (Indoor Positioning System). If a spatial proximity is defined, access is approved so that for example external data can be stored in a secured storage area in the IoT device. The external data can be transmitted directly by the smartphone or preferably by way of the server or the cloud into the secured storage area of the IoT device.

In order to further increase security, the ID codes emitted by the positioning beacons are transmitted in encrypted form to an IPS server in the cloud, such as e.g. by means of a rolling code. As a result the current position in a building cannot be determined directly by the smartphone itself, but instead only by the IPS server. “Feigning” a position in a building is therefore not possible. In some embodiments, an increased degree of security is possible for the access to the secured storage area of an IoT device. In addition to the virtual component (IP access), a physical component (location) is required to activate the data transfer. Moreover, the physical access to the device can further be ensured by means of access control systems.

Even in the case of a hacker attack onto the IoT cloud server (with the BIM data), no manipulation of the built-in IoT device is possible. Furthermore, no manipulation is possible even in the case of a hacker attack directly onto the IoT device, since a write access is only possible by way of approval from the cloud server, such as e.g. by means of the cloud server itself.

By means of the methods taught herein and the secured access to the cloud server (e.g. PKI login), it is no longer necessary in future to enter passwords or implement complicated configurations.

The methods and the systems incorporating teachings of the present disclosure for authorizing the communication of a network node of a communication network are particularly suited to applications with high security requirements. They are therefore particularly suited to the commissioning and maintenance or the testing of IoT devices with high security requirements or in environments with high security requirements or with sensitive infrastructure (e.g. in banks, prisons, protection zones, military installations, disaster response organizations, nuclear facilities, power plants). The IoT devices can, for example, be fire detectors or hazard detectors which are connected to the Internet or Intranet.

### REFERENCE SIGNS

IPS Positioning determination system
BIM Building model
POS, POS_{BIM}, POS_{IP}S Position data
REQ Request
DB1, DB2 Database
FW Firmware
GRANT Approval
CLOUD Cloud infrastructure
CSA Cloud service application
GW Gateway
IoT1-IoT4 IoT device
PANEL Control and operating panel
ML Detector line
AL Alarm
BAT Battery
M Memory
SMART Mobile communication terminal
DIS Display
APP Application program
IP1, IP2 IP connection
BT Bluetooth connection
PB1-PB4 Positioning beacon
ID1-ID4 Identification (ID)
ID1-*ID4, IDn Identification (ID)
MAP Map
VS1, VS1 Method step

What is claimed is:

1. A method for authorizing the communication of a network node of a communication network, the method comprising:
comparing a geographic position of the network node to a geographic position of a defined mobile communication terminal; and
authorizing the network node for communication only if the geographic position of the network node and the position of a defined mobile communication terminal essentially match.

2. The method as claimed in claim 1, further comprising:
storing the position of the network node in a building model on a server; and wherein
determining the position of the mobile communication terminal using a position determination system.

3. The method as claimed in claim 2, wherein the server performs verification of the position.

4. The method as claimed in claim 1, wherein the network node verifies the position of the network node.

5. The method as claimed in claim 1, wherein the mobile communication terminal verifies the position of the mobile communication terminal.

6. The method as claimed in claim 1, wherein the mobile communication terminal verifies the position of network nodes the position of the mobile communication device using an NFC connection between the network node and the mobile communication terminal.

7. The method as claimed in claim 1, wherein throughout a duration of a communication, the position of the network node and the position of the mobile communication terminal must essentially match.

8. The method as claimed in claim 1, wherein the mobile communication terminal (SMART) receives a certification by way of a certification server.

9. The method as claimed in claim 1, further comprising permitting a write access to a memory of the authorized network node only following a completed authorization.

10. (canceled)

11. A system for authorizing the communication of a network node of a communication network, the system comprising:
a server storing a building model including a geographic position of the network node; and
a position determination system for determining a position of a mobile communication terminal;
wherein authorization for communication of the network node only takes place if the geographic position of the network node and the position of the mobile communication terminal essentially match.

12. The system as claimed in claim 11, wherein at least one of the network node, the server, and the mobile communication terminal checks the position of the mobile communication terminal and the position of the network node.

13. The system as claimed in claim 11, wherein following completed authorization, the network node is configured to allow a write access to a memory of this authorized network node.

14-16. (canceled)
